(19) United States
(12) Patent Application Publication
(10) Pub. No.: US 2025/0328016 A1
(43) Pub. Date: Oct. 23, 2025

(54) SMART GLASSES AND METHOD FOR PROJECTING A PROJECTION IMAGE

(71) Applicant: Robert Bosch GmbH, Stuttgart (DE)

(72) Inventor: Gael Pilard, Wankheim (DE)

(21) Appl. No.: 18/863,529

(22) PCT Filed: Dec. 11, 2023
(86) PCT No.: PCT/EP2023/085063

§ 371 Date: Nov. 6, 2024

(30) Foreign Application Priority Data
Jan. 17, 2023 (DE) 10 2023 200 307.4

(51) Int. Cl. G02B 27/01; G06F 3/01

(52) U.S. Cl. CPC G02B 27/0172; G06F 3/013; G02B 2027/0174; G02B 2027/0178

(57) ABSTRACT

Smart glasses including an optical system for projecting a projection image onto an imaging region of an eye. The optical system includes a light source for outputting an image, a tracking module for acquiring the pupil position of a pupil of the eye, and an image forming module for forming the output image into a to-be-projected image. The image forming module is configured to change an image plane of the to-be-projected image as a function of a pupil position acquired by the tracking module. The optical system also includes a reflection module, which is configured to project the to-be-projected image as a projection image into the imaging region of the eye.

### FIELD

The present invention relates to smart glasses and a method for projecting a projection image. The subject matter of the present invention also includes a computer program.

### BACKGROUND INFORMATION

Intelligent glasses, so-called smart glasses, can include optical systems for superimposing a virtual image on normal vision. So-called retina scan displays in particular describe systems with which an image is projected directly onto the retina of the user through the pupil. These systems can be built with a laser scanner module alongside a holographic element that redirects the light through the pupil of the user. One characteristic of VR systems that are based on laser scanners and use a hologram element is that they have a small eye box. The glasses should therefore fit the user perfectly and the user is supposed to position his/her pupil in a specific location in order to not lose the image.

### SUMMARY

The approach presented here introduces improved smart glasses and an improved method for projecting a projection image, and a corresponding computer program. Advantageous embodiments, developments, and improvements of the present invention are disclosed herein.

The smart glasses of the present invention presented here include an optical system with which an eye box can advantageously be adjusted to a gaze direction of a user of the smart glasses.

Smart glasses comprising an optical system for projecting a projection image onto an imaging region of an eye are presented. According to an example embodiment of the present invention, the optical system of the smart glasses comprises a light source for outputting an image, a tracking module for acquiring the pupil position of a pupil of the eye, and an image forming module for forming the output image into a to-be-projected image. The image forming module is configured to change an image plane of the to-be-projected image as a function of a pupil position acquired by the tracking module. The optical system also comprises a reflection module, which is configured to project the to-be-projected image as a projection image into the imaging region of the eye.

The smart glasses can be AR glasses, for example, i.e. glasses comprising so-called augmented reality displays. With these systems, a virtual image can be superimposed on the normal vision of a wearer of the glasses. The optical system of the smart glasses presented here can also be used to create a so-called retina scan display, in which an image, i.e. the projection image, can be projected directly onto the retina of a user through the pupil. The size of the optical beam projected into the pupil in these systems is typically limited, because the size of the individual components of the optical system of the smart glasses is limited. The optical beam that enters the pupil should moreover be small enough that a resulting spot size on the retina does not depend heavily on the accommodation of the eye. These and similar realities therefore constitute restrictions for the possible imaging region on the pupil in which the projection image can be imaged. The imaging region, which can also be referred to as the eye box, defines the region in which the pupil should be positioned in order to see the entire image. The optical system of the smart glasses presented here advantageously makes it easier to find this eye box or to dynamically adjust the imaging region to a pupil position of the user. For this purpose, the optical system comprises, among other things, a light source, which can be a laser module with at least one laser, for instance, for outputting an image. Using the tracking module, which can also be referred to as an eye tracking module, advantageously makes it possible to measure the pupil position of the user. For example, it is possible to detect whether a user of the smart glasses changes his/her gaze direction, for instance moves the pupil vertically or horizontally. Changing the pupil position also changes the region in which an image projected through the smart glasses can be seen sharply and in its entirety. In other words, the imaging region or the eye box depends on the gaze direction of the eye. The optical system presented here advantageously comprises an image forming module that can change the to-be-projected image as a function of the acquired pupil position. Specific regions of the image or the entire image can, for instance, be distorted by the image forming module, which can also be referred to as a dynamic eye box group, to such an extent that, when it is projected in the imaging region, the eye can perceive it again as a normally proportioned image. In other words, the smart glasses presented here provide the advantage that the system is able to calibrate itself to the pupil position of the user by ascertaining the pupil position and adjusting the eye box accordingly. During operation, it can enable the best resolution in the central field of view by following the eye movements of the user and enabling a natural view.

According to one example embodiment of the present invention, the image forming module can be configured to change the image plane of the to-be-projected image by tilting and additionally or alternatively rotating an image forming module element. The image forming module can comprise at least one reflective element, for example, for instance a micromirror, which can be configured such that it can be tilted or reduced about at least a longitudinal axis and a transverse axis. This advantageously makes it possible to adjust the image plane of the to-be-projected image particularly finely, which enables advantageous changes, such as shifts in the image or distortions.

According to another example embodiment of the present invention, the image forming module can be configured to change a position of the imaging region of the projection image. The image forming module can be used to shift the position of the eye box in the pupil plane of the user, for example. This provides the advantage that the projection image can be perceived without any problems even if the gaze direction changes.

According to another example embodiment of the present invention, the image forming module can be configured to change an extent of the imaging region of the projection image. The image forming module can be used to increase the imaging region, for example; i.e. the eye box as a whole can be expanded. This provides the advantage that the projection image can be projected onto a larger region and can be perceived more easily by the eye.

According to another example embodiment of the present invention, the image forming module can comprise at least one movable lens element and additionally or alternatively a micromirror element. The image forming module can be configured with a movable lens, i.e. a tiltable and additionally or alternatively rotatable lens, and also with a likewise movable 2D micromirror, for example. The position of the eye box in the pupil plane of the user can be shifted by tilting the micromirror, for instance. Combining a lens element with a mirror element provides the advantage that the image plane of the to-be-projected image, and thus the imaging region of the projection image, can be changed in a particularly detailed manner.

According to another example embodiment of the present invention, the optical system of the smart glasses can comprise a focusing module for focusing the output image and additionally or alternatively the to-be-projected image. Such an optical focused group can consist of a tunable lens and a focusing lens, for example. The order of the individual lenses in the system can be variable and can be selected according to the smart glasses. The focusing module can advantageously be used to set a resolution of the projected image on the retina and also a beam size in the pupil plane of the user.

According to another example embodiment of the present invention, the optical system of the smart glasses can comprise a mirror module for redirecting the to-be-projected image onto the reflection module. The mirror module can comprise one or more micromirrors, for example, that can be aligned such that the to-be-projected image can advantageously be optimally directed to the reflection module.

According to another example embodiment of the present invention, the reflection module can be configured with at least one holographic optical element. The reflection module can comprise one or more HOEs, for example, which can be displayed in a lens of the smart glasses, for instance. The holographic optical elements can advantageously be used to redirect the to-be-projected image with particular precision and project it as a projection image onto the imaging region in the pupil plane of the user.

According to another example embodiment of the present invention, the optical system can be manufactured using MEMS technology. In particular the dynamic position adjustment of the eye, for example, can be realized using a MEMS system. This has advantage that all of the elements used can be particularly small, i.e. miniaturized. All in all, the system can be very small and can therefore be integrated into a small lens format of the smart glasses.

A method for projecting an image onto an imaging region of an eye according to the present invention is presented as well. According to an example embodiment of the present invention, the method comprises a step of outputting the image, a step of acquiring a pupil position of the eye and a step of forming the output image into a to-be-projected image. This involves changing an image plane of the to-be-projected image as a function of the acquired pupil position. The method also comprises a step of projecting the to-be-projected image as a projection image into the imaging region of the eye.

This method of the present invention can be implemented in software or hardware, for instance, or in a mixed form of software and hardware, for example in a control unit.

A computer program product or a computer program comprising program code that can be stored on a machine-readable carrier or storage medium, such as a semiconductor memory, a hard disk memory or an optical memory, and can be used to carry out, implement and/or control the steps of the method according to one of the above-described embodiments of the present invention is advantageous as well, in particular when the program product or program is executed on a computer or a device.

Embodiment examples of the present invention disclosed herein are shown in the figures and explained in more detail in the following description.

### BRIEF DESCRIPTION OF THE DRAWINGS

FIG. 1 shows a schematic illustration of smart glasses according to an embodiment example of the present invention.

FIG. 2 shows a schematic illustration of an optical system of smart glasses according to an embodiment example of the present invention.

FIG. 3 shows a schematic illustration of an optical system of smart glasses according to an embodiment example of the present invention.

FIG. 4 shows a flowchart of an embodiment example of a method for projecting an image onto an imaging region, according to the present invention.

FIG. 5A shows a schematic illustration of an optical system of smart glasses according to an embodiment example of the present invention.

FIG. 5B shows a diagram of a shifted imaging region according to an embodiment example of the present invention.

FIG. 6 shows a schematic illustration of a rotated projection image according to an embodiment example of the present invention.

FIG. 7 shows a schematic illustration of a shifted imaging region 200b according to an embodiment example of the present invention.

FIG. 8 shows a schematic illustration of a rotation ability of an eye according to an embodiment example of the present invention.

FIG. 9 shows a schematic illustration of the vision of an eye according to an embodiment example of the present invention.

FIG. 10 shows a schematic illustration of optical system of smart glasses according to an embodiment example of the present invention.

### DETAILED DESCRIPTION OF EXAMPLE EMBODIMENTS

In the following description of favorable embodiment examples of the present invention, the same or similar reference signs are used for the elements which are shown in the various figures and have a similar effect, and a repeated description of these elements is omitted.

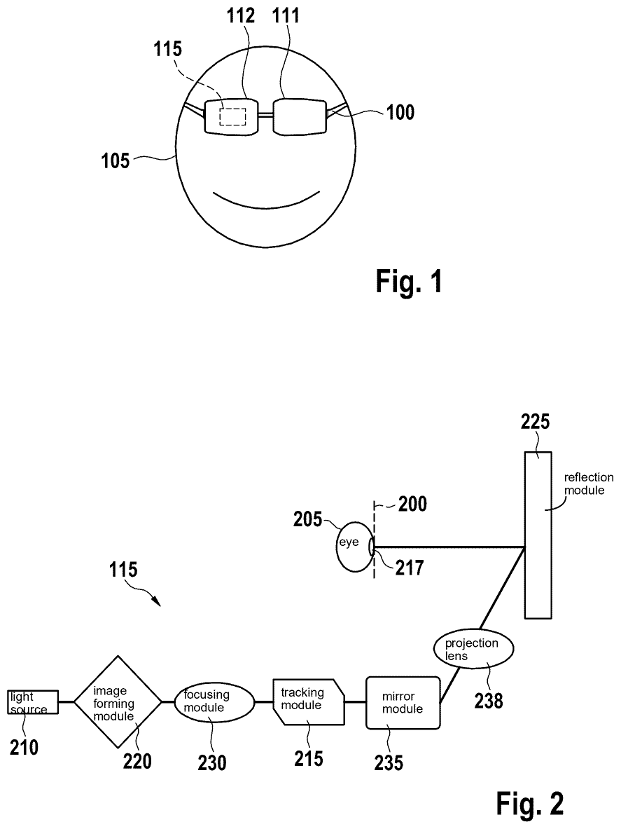

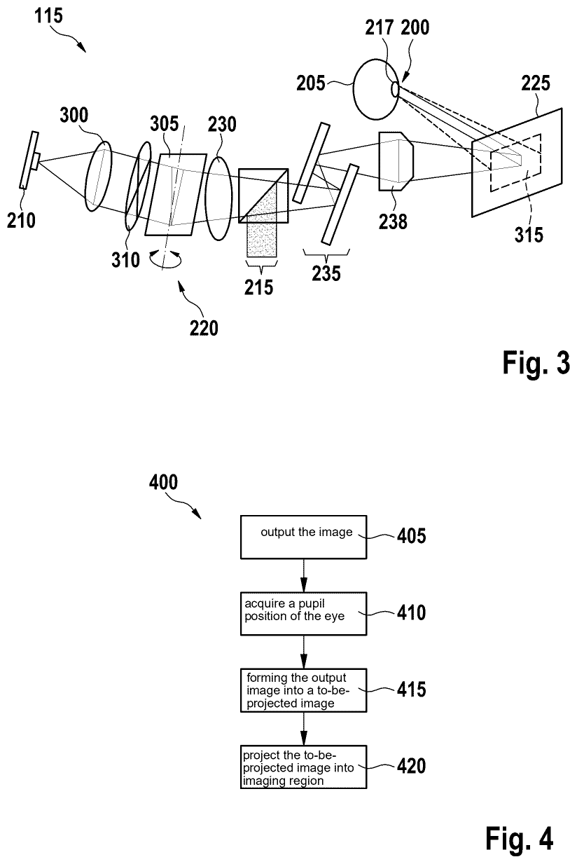

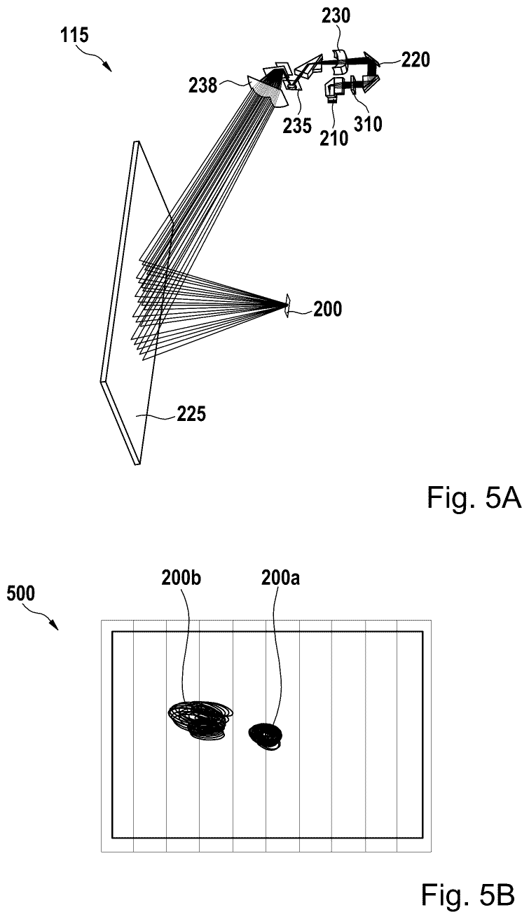

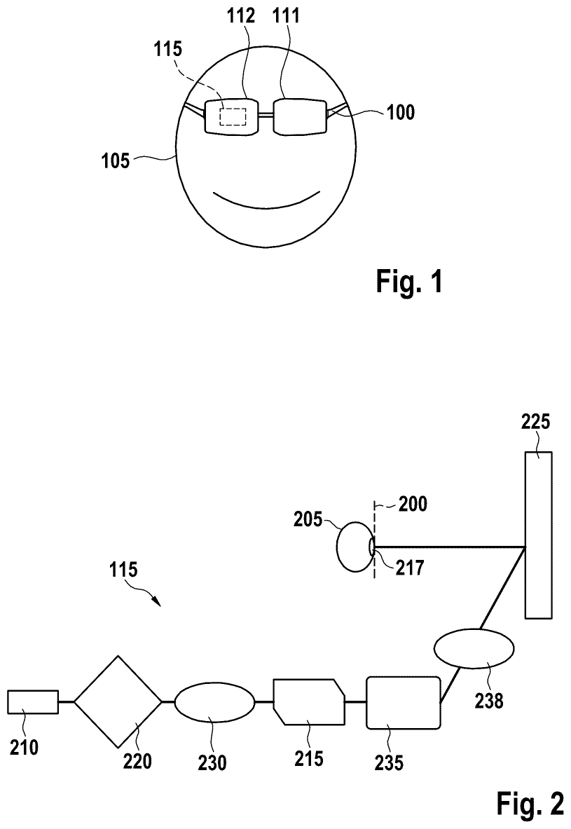

FIG. 1 shows a schematic illustration of smart glasses 100 according to an embodiment example. In the embodiment example shown here, the smart glasses 100, which can also be referred to as intelligent glasses, are positioned on the head of a user 105 in such a way that the lenses 111, 112 cover the eyes of the user. The smart glasses 100 shown here are configured as so-called AR glasses with an augmented reality display to superimpose virtual images on the normal vision of the user 105. The smart glasses 100 are in particular configured with a retina scan display, i.e. with a system in which an image is scanned directly onto the retina of the user through the pupil. As an example, these systems include a laser scanner module alongside a holographic optical element that redirects the light through the pupil of the user 105.

The size of the optical beam projected into the pupil in these systems is typically limited, because the size of the elements used in the system is limited. The optical beam that enters the pupil should also be small, so that the resulting spot size on the retina does not depend heavily on the accommodation of the eye. The resulting imaging region at the pupil, the so-called eye box (which defines the region in which the pupil has to be positioned in order to see the entire image), is therefore limited.

The smart glasses 100 shown here comprise an optical system 115, described in more detail in the following figures, which enables the user 105 to easily find the eye box and/or dynamically adjust the eye box to the pupil position of the user. A particular embodiment with a moving element that can be manufactured using MEMS technologies is proposed here.

FIG. 2 shows a schematic illustration of an optical system 115 of smart glasses according to an embodiment example. The optical system 115 shown here corresponds to or is similar to the optical system described in the preceding figure and can be used in smart glasses as described above.

The optical system 115 is configured to project a projection image onto an imaging region 200 of an eye 205. For this purpose, the optical system 115 comprises a light source 210 for outputting an image. In one embodiment example, this is a laser module comprising at least one laser.

The optical system 115 also comprises a tracking module 215 for acquiring the pupil position of a pupil 217 of the eye 205. The tracking module 215 can also be referred to as an eye tracking module.

The optical system 115 further comprises an image forming module 220, which is configured to convert the image output by the light source 210 into a to-be-projected image. The image forming module 220 can also be referred to as a dynamic eye box group and is configured to change an image plane of the to-be-projected image in response to a pupil position acquired by the tracking module 215. This makes it possible to shift a position of the imaging region 200 in the pupil plane of the user.

The to-be-projected image can be projected into this imaging region 200 of the eye 205 as a projection image by means of a reflection module 225. In one embodiment example, the reflection module 225 is configured with a holographic optical element (HOE) in order to bundle light beams directed onto it and redirect them as a projection image onto the imaging region 200.

In one embodiment example, a focusing module 230 is additionally disposed between the image forming module 220 and the tracking module 215 for example and, in one embodiment example, is configured to focus the to-be-projected image. In one embodiment example, such a focusing element group is configured to set a resolution of the image on the retina of the user and also a beam size in the pupil plane.

In one embodiment example, the optical system 115 also comprises a mirror module 235 that is disposed, merely as an example, between the tracking module and the reflection module and is configured to redirect the to-be-projected image onto the reflection module 225. In one embodiment example, the mirror module 235 comprises at least one micromirror for this purpose. Just as an example, the to-be-projected image can be directed by the micromirror onto a projection lens 238, which directs the light beams once again bundled onto the reflection module.

In other words, the design shown here includes a laser module with at least one laser, a dynamic eye box group that has the function of shifting the position of the eye box in the pupil plane of the user, a focusing element group that has the function of setting the resolution of the projected image on the retina and setting the beam size in the pupil plane of the user, an eye tracking module that has the function of measuring the pupil position of the user, a micromirror module that has the function of directing the beam to the HOE, a lens or a projection element that has the function of adjusting the image directed by the micromirror to the desired illumination region on the HOE, and a reflection element that uses an HOE on the lens and has the function of redirecting the illuminated region to an eye box in the pupil plane of the user.

Of course, the order of the different groups in the present invention is not fixed, but can be selected according to the requirements and constraints of the optical design. The movable part for implementing the dynamic eye box functionality can optionally be integrated into the focusing group, such as in a lens with a movable focus.

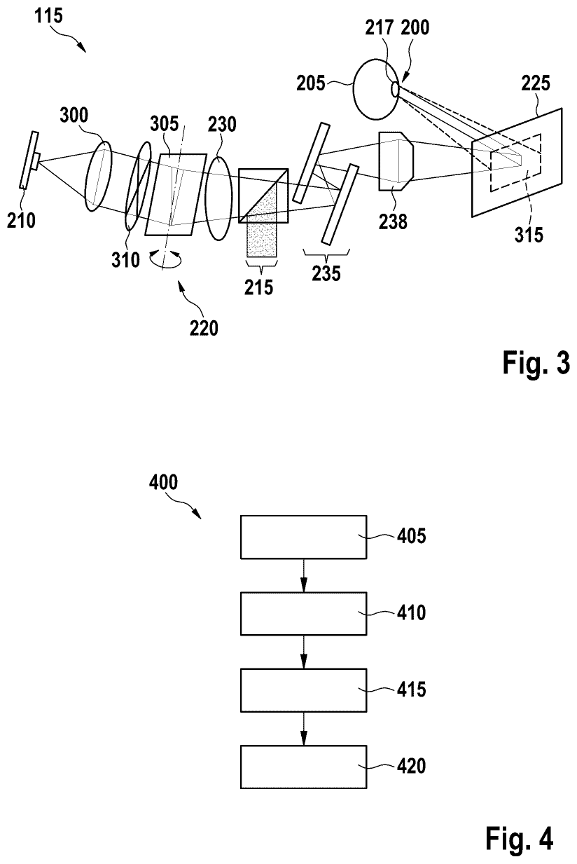

FIG. 3 shows a schematic illustration of an optical system 115 of smart glasses according to an embodiment example. The optical system 115 shown here corresponds to or is similar to the optical system described in the preceding figure and is configured for smart glasses as described in the preceding FIG. 1 to project a projection image onto an imaging region 200 of an eye 205. The optical system of the smart glasses comprises the light source 210 for outputting an image, a tracking module 215 for acquiring the pupil position of a pupil 217 of the eye 205, and an image forming module 220 for forming the output image into a to-be-projected image. The image forming module 220 is configured to change an image plane of the to-be-projected image as a function of a pupil position acquired by the tracking module 215. The optical system also comprises a reflection module 225, which is configured to project the to-be-projected image as a projection image into the imaging region 200 of the eye 205.

In this embodiment example, a collimating lens 300 is additionally disposed between the light source 210 and the image forming module 220. The collimating lens 300 is configured to collimate the light emitted by the light source or the laser beam in order to direct it bundled in this manner onto the image forming module 220.

In this embodiment example, the image forming module 220 comprises a micromirror element 305 that can be moved about both a longitudinal axis and a transverse axis, for example. It can be tilted along these axes, for example, or also rotated. The image forming module 220 is thus configured to change the image plane of the to-be-projected image by tilting and/or rotating this image forming module element.

Just as an example, the image forming module 220 is configured to change a position of the imaging region 200 of the projection image. By accordingly tilting the micromirror element, the imaging region can be moved, for example from a region in front of the face to a slightly lateral position, so that, when the gaze direction of the eye 205 changes, for instance when looking to the side, the projection image is still sharp and can be perceived in detail. The image forming module 220 is furthermore configured to change an extent of the imaging region of the projection image, for instance, for example to enlarge it.

In other words, the optical system 115 shown here can be used to collimate at least one laser beam by means of a collimating lens 300, wherein optionally more than one laser can be used and combined by suitable optics before it enters the focusing optical group.

In this embodiment example, the optical focusing group comprises a tunable lens 310, which is, merely as an example, disposed between the collimating lens 300 and the image forming module 220, and a focusing lens 230. The order and position of the lenses in the system is variable and can be selected accordingly. The dynamic eye box module is shown here as a 2D micromirror. Tilting the beam direction on the micromirror element 305 makes it possible to shift the eye box in the pupil plane of the user after projection onto the reflection module 225, which is configured as an example here with an HOE, through the projection lens 238. An eye tracking system is added to the beam path, for example with an infrared (IR) transmitting element. This function of this module is to ascertain the pupil position in the pupil plane of the user. The mirror element 237 can be implemented with a combination of two 1D scanning elements, for example, or also with a 2D scanning mirror. The use of two 1D mirrors has advantages discussed further below, in particular if the first mirror is fast and resonant and scans vertically in the HOE plane and the second mirror is quasi-static and scans horizontally in the HOE plane.

The projection lens 238 forms the to-be-projected image, which is redirected by the mirror module 235, such that it fills the desired region in the HOE plane. The reflection element 225 directs the light in the projection surface 315 onto the imaging region 200 in the pupil plane of the user.

FIG. 4 shows a flowchart of an embodiment example of a method 400 for projecting an image onto an imaging region of an eye. The method 400 comprises a step 405 of outputting the image, a step 410 of acquiring a pupil position of the eye and a step 415 of forming the output image into a to-be-projected image. This involves changing an image plane of the to-be-projected image as a function of the acquired pupil position. The method 400 also comprises a step 420 of projecting the to-be-projected image as a projection image into the imaging region of the eye.

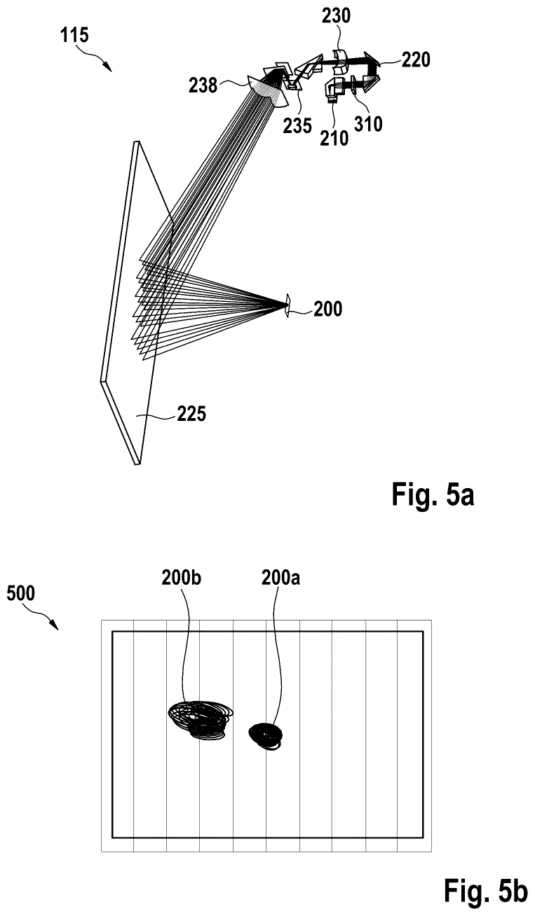

FIG. 5A shows a schematic illustration of an optical system 115 of smart glasses according to an embodiment example. The optical system 115 shown here corresponds to or is similar to the optical system described in the preceding FIGS. 1, 2 and 3.

The position of the imaging region 200 in the pupil plane of the user can be shifted by tilting the example 2D micromirror of the image forming module 220. Tilting by an example angle α in this micromirror direction corresponds to an eye box shift δd, wherein the direction of the shift is correlated with the orientation of the tilt angle α. An example of such an eye box shift is shown in the following FIG. 5B.

FIG. 5B shows a diagram 500 of a shifted imaging region 200b according to an embodiment example. As an example, the scale of the diagram 500 is 2.2000 mm to 3.2000 mm.

A shift of the eye box is achieved here in accordance with the tilting of the image forming module described in the preceding FIG. 5A. Mechanical tilting of the example 2D mirror by 1.0° in horizontal direction achieves a 0.65 mm eyepiece shift of the original imaging region 200a to the shifted imaging region 200b.

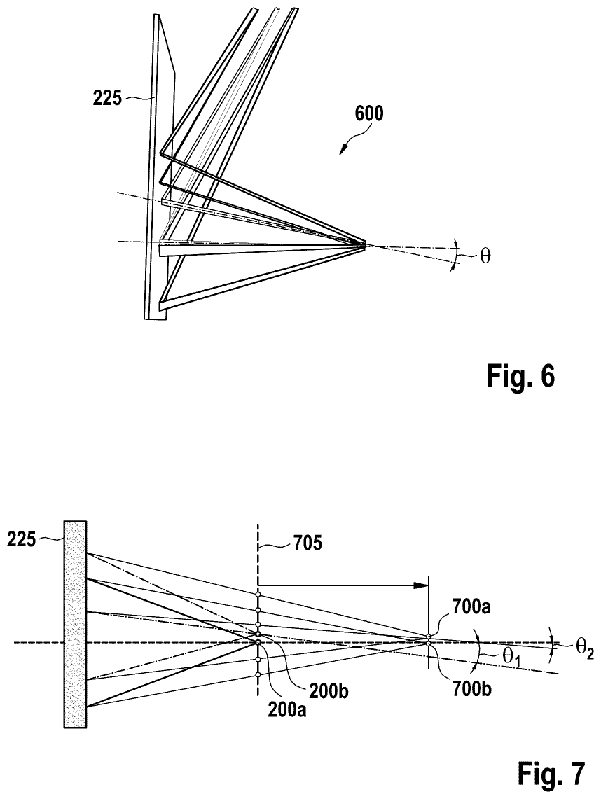

FIG. 6 shows a schematic illustration of a rotated projection image 600 according to an embodiment example.

Closer examination of the eye box formation shows that, with a specific shift of the image forming module, a rotation of the projection image 600 that enters the eye of the user can be observed. In our case and as shown in this figure, an example eye box shift is shown for the middle and the outermost horizontal light beam with and without eye box shift. It can be seen that the middle beam direction between the two eye boxes is tilted. In the case of the present simulation, the angle of rotation θ for the shifted eye box at a distance of 0.65 mm is already 10°. The image could be corrected digitally, but more than 10° would mean a direct reduction of half the field of view by 10°. Part of the present invention is to correct this problem and to build a functioning system by reducing the usable field of view (FOV). The angle of rotation θ is minimized when the eye box formation is set. This geometric effect is shown below in the following FIG. 7.

FIG. 7 shows a schematic illustration of a shifted imaging region 200b according to an embodiment example.

When the convergence points 700a, 700b are moved behind the pupil plane 705 of the user, the angle of rotation θ₁ is reduced to θ₂. A convergence point can, for example, be understood as a vanishing point at which a point in the pupil plane is imaged onto a region behind the pupil plane or to which this point on the pupil plane appears to be moving. However, the displacement of the convergence points 700a, 700b to behind the pupil of the user means that the image beams do not intersect the pupil plane of the user at a single point, but that the intersection point of the individual beams is separated from the others. If the area covered by the intersection points is large, not all of the beams will enter the pupil of the user. The convergence point behind the pupil position of the user is therefore limited.

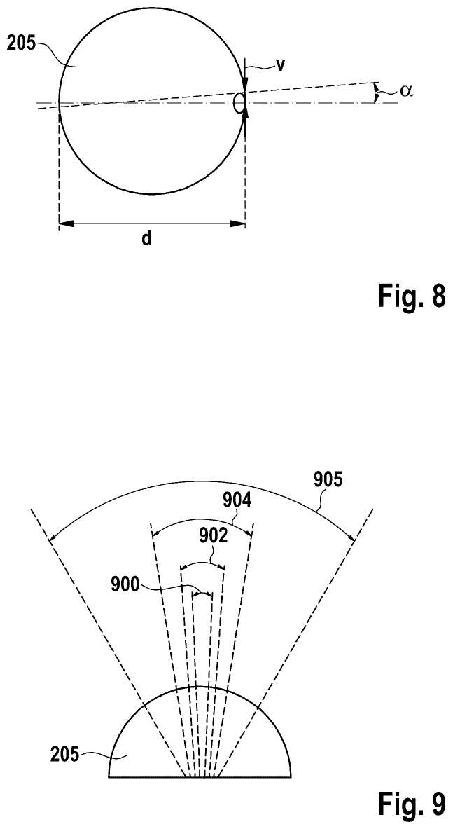

FIG. 8 shows a schematic illustration of a rotation ability of an eye 205 according to an embodiment example.

To balance the ability of the pupil of the user to perceive every beam direction and the need to minimize image rotation when shifting the eye box, it is possible to utilize the characteristics of the human eye by evaluating the rotation of the eye relative to the pupil shift and the field of view characteristics of human vision.

The standard model (e.g. the Gullstrand model) of the eye 205 uses an eyeball having a diameter d of 24.0 mm. Taking a rotation in the middle into account, a shift v of 0.65 mm as shown in the preceding FIG. 5B corresponds to a shift of the eyeball or an eye rotation α of 3.1°. This is significantly less than the 10° image rotation we observed and should be reduced.

The features of vision shown in the following FIG. 9 can be used for this purpose.

FIG. 9 shows a schematic illustration of the vision of an eye 205 according to an embodiment example.

The sharpness of the human eye 205 decreases with the angular extent of the observed scene. The central view 900 is the sharpest and decreases toward the paracentral angles 902, toward the macular angles 904, and lastly toward the near peripheral angles 906. Consideration of larger viewing angles is unnecessary because they are not relevant for small-format smart glasses in which the usable field of view is limited by the compactness of the optical system.

In this embodiment example, a Gaussian standard deviation of about 2 minutes arc length at 10° eccentricity is assumed as an example. In this simulation, this corresponds to an approximately 3 to 4 times larger spot at the location of the pupil plane of the user. The proposed above-described optical system then adjusts the HOE characteristic to set the beam convergence behind the pupil plane of the user. The horizontal movement of the micromirror module is synchronized with the tunable focus lens to defocus the beam at a larger angle and increase the beam size in the pupil plane of the user. This enables every light beam to enter the pupil of the user, even if the beams do not all intersect the pupil plane of the user in a common location.

The eye tracking system follows the pupil position of the user so that the tunable lens always sees the gaze direction sharply and defocuses accordingly as it moves away from the gaze direction. The dynamic eye box movement system also adapts to the position of the user. When the system is perfectly adjusted, the natural rotation of the eye correlates with the corresponding rotation of the projected image. A digital image correction is responsible for adjusting the two rotations and provides the viewer with a natural view of the projected image. By adjusting the system as described in the preceding FIG. 5A, the convergence point can be moved behind the pupil plane of the user.

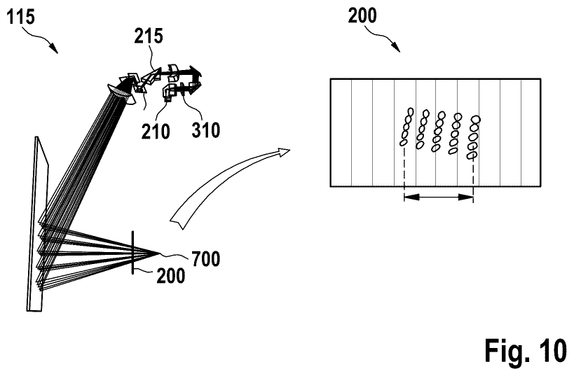

FIG. 10 shows a schematic illustration of optical system 115 of smart glasses according to an embodiment example. The optical system 115 shown here corresponds to or is similar to the optical system described in the preceding FIGS. 1, 2, 3, 5A and 5B. The imaging region 200 is additionally shown in the illustration shown here as a diagram.

In this embodiment example, an extent l of the eye box in lateral direction is 3.5 mm, merely as an example. As explained above, a pupil having a 3.5 mm diameter should now be exactly centered in order to see the projection image. To ensure that every image beam is perceived even with a smaller or decentered pupil, the lens element 310, i.e. the tunable lens, defocuses the beam to compensate the perception weakness of the human eye and de facto increases the beam size at the edge of the scanning amplitude. A portion of the lateral beams is cut off at the outer imaging region. The loss of image intensity can be compensated, for example, by adjusting the laser power of the light source 210 and by using the tracking module 215 to take into account the pupil size and/or an ambient light sensor to adjust to the expected pupil size.

With the modified design, a rotation of the projected image can be reduced to 5.2°, which in this embodiment example corresponds to a shift of the eye box formation of 0.65 mm. The overall extent of the eye box is now 3.50+2*0.65=4.80 mm, for example, wherein the additional extent of the defocused spots due to lateral scanning is not taken into account.

An example shift of the eye space by 0.65 mm corresponds to an eye rotation of 3.1°. The digital correction should take into account (5.2°−3.1°=2.1°). The field of view should therefore be increased to twice this value, i.e. to about 5°. This is an acceptable compromise, because the scanning amplitude can be increased with the micromirror size and/or the illumination surface projected onto the HOE plane can be accordingly increased with a suitable design of the projection lens.

Overall, the smart glasses with the described optical system described with reference to the preceding figures can be summarized as follows:

It is a system with an adaptive dynamic eye box. The system is able to calibrate itself to the pupil position of the user by ascertaining the pupil position prior to projecting an image and moving the eye box accordingly. During operation, the system follows the pupil position and enables the best resolution in the central field of view by following the eye movements of the user and enabling a natural view. The expansion of the eye box and the tracking of the pupil position, so that the user can still easily see an image even when the gaze direction changes, is another advantage of the present invention. The dynamic position adjustment of the eye can moreover be realized with a MEMS system, and thus miniaturized and industrialized. All in all, the concept remains small and can be integrated into a small lens format.

If an embodiment example comprises an “and/or” conjunction between a first feature and a second feature, this is to be read to mean that the embodiment example comprises both the first feature and the second feature according to one embodiment, and either only the first feature or only the second feature according to another embodiment.

1-13. (canceled)

14. Smart glasses, comprising:
an optical system configured to project a projection image onto an imaging region of an eye, wherein the optical system includes:
a light source configured to output an image,
a tracking module configured to acquire a pupil position of a pupil of the eye,
an image forming module configured to form the output image into a to-be-projected image, wherein the image forming module is configured to change an image plane of the to-be-projected image as a function of the pupil position acquired by the tracking module, and
a reflection module which is configured to project the to-be-projected image as the projection image into the imaging region of the eye.

15. The smart glasses according to claim 14, wherein the image forming module is configured to change the image plane of the to-be-projected image by tilting and/or rotating an image forming module element.

16. The smart glasses according to claim 14, wherein the image forming module is configured to change a position of the imaging region of the projection image.

17. The smart glasses according to claim 14, wherein the image forming module is configured to change an extent of the imaging region of the projection image.

18. The smart glasses according to claim 14, wherein the image forming module includes at least one movable lens element and/or a micromirror element.

19. The smart glasses according to claim 14, further comprising:
a focusing module configured to focus or defocus: (i) the output image or output image beams, and/or (ii) the to-be-projected image.

20. The smart glasses according to claim 14, further comprising:
a mirror module configured to redirect the to-be-projected image onto the reflection module

21. The smart glasses according to claim 14, wherein the reflection module is configured with at least one holographic optical element.

22. The smart glasses according to claim 14, wherein the optical system is manufactured using MEMS technology.

23. The smart glasses according to claim 14, wherein: (i) the smart glasses are configured such that convergence points behind a pupil plane of the user are shifted and/or an intersection point of individual beams in the pupil plane of the user is separated from other intersections, and/or (ii) a tunable focus lens is provided or synchronized to defocus a beam at an angle greater than an angle of incidence and/or to increase a lateral beam size in the pupil plane of the user.

24. A method for projecting an image onto an imaging region of an eye, the method comprising the following steps:
outputting the image;
acquiring a pupil position of the eye;
forming the output image into a to-be-projected image, wherein an image plane of the to-be-projected image is changed as a function of the acquired pupil position; and
projecting the to-be-projected image as a projection image into the imaging region of the eye.

25. A non-transitory machine-readable storage medium on which is stored a computer program for projecting an image onto an imaging region of an eye, the computer program, when executed bv a computer, causing the computer to perform or control the following steps:
outputting the image;
acquiring a pupil position of the eye;
forming the output image into a to-be-projected image, wherein an image plane of the to-be-projected image is changed as a function of the acquired pupil position; and
projecting the to-be-projected image as a projection image into the imaging region of the eye.
